(19) United States
(12) Patent Application Publication
(10) Pub. No.: US 2012/0325600 A1
(43) Pub. Date: Dec. 27, 2012

(54) Monoblock Brake Caliper Having Crossover Reinforcement Elements

(76) Inventor: Stephen John Ruiz, Redondo Beach, CA (US)

(21) Appl. No.: 13/529,808

(22) Filed: Jun. 21, 2012

Related U.S. Application Data
(60) Provisional application No. 61/499,670, filed on Jun. 21, 2011.

(51) Int. Cl. F16D 65/095

(52) U.S. Cl. 188/73.31

(57) ABSTRACT

Provided is, among other things, a disc brake caliper that includes: a unitary main housing, a leading reinforcement element and a trailing reinforcement element. The unitary main housing is made of a first material and includes: (a) an inner portion, (b) an outer portion, (c) a leading crossover section that extends between the inner portion and the outer portion, forward of both the inner opening and the outer opening, and over the brake rotor when in use, and (d) a trailing crossover section that extends between the inner portion and the outer portion, behind both the inner opening and the outer opening, and over the brake rotor when in use.

### FIELD OF THE INVENTION

The present invention pertains to disc brake calipers, e.g., of the type used on many automobiles.

### BACKGROUND

Generally speaking, a disc brake caliper is the main housing for hydraulically actuated piston(s) and corresponding brake pads. In use, the brake pads are arranged against opposite sides of a brake rotor. When actuated, the piston(s) press against the back(s) of at least one of the brake pads, pressing the brake pads against the rotor, and thereby providing frictional resistance for slowing down the vehicle (typically, an automobile).

Different types of disc brake calipers exist. There are two primary types, described as fixed mounting, opposed multi-piston type and non-fixed, inside single or multi-piston sliding body type. Of the former, variations among different calipers involve, for example, the number of piston(s) that are used (e.g., from 2-10 pistons), the material(s) from which the caliper is made, and whether the caliper is manufactured as a unitary component or as two separate components. When manufactured from two separate components, one of the components typically includes the inner piston cavities and the other component includes the outer piston cavities; during manufacture, the two components are attached (typically bolted) together.

Unfortunately, each conventional brake caliper structure has its own drawbacks, e.g., in terms of construction cost, weight and/or performance. As a result, improvements in caliper construction remain continuously desirable, particularly where high-performance is a significant issue.

### SUMMARY OF THE INVENTION

The present invention addresses these concerns by, among other things, providing a monoblock brake caliper that uses crossover reinforcement elements (such as bolts) and, in certain embodiments, a bracing structure (such as a truss) to enhance the uniformity of the brake pad pressure against the rotor.

Thus, one embodiment of the invention is directed to a disc brake caliper that includes: a unitary main housing, a leading reinforcement element and a trailing reinforcement element. The unitary main housing is made of a first material and includes: (a) an inner portion that is adjacent to an inner side of a brake rotor when in use and includes an inner opening for receiving an inner brake pad, (b) an outer portion that is adjacent to an outer side of a brake rotor when in use and includes an outer opening for receiving an outer brake pad, (c) a leading crossover section that extends between the inner portion and the outer portion, forward of both the inner opening and the outer opening, and over the brake rotor when in use, and (d) a trailing crossover section that extends between the inner portion and the outer portion, behind both the inner opening and the outer opening, and over the brake rotor when in use. The leading reinforcement element extends between the inner portion and the outer portion through the leading crossover section, and the trailing reinforcement element extends between the inner portion and the outer portion through the trailing crossover section. Each of the leading and trailing reinforcement elements has a Young's modulus that is at least twice that of the first material.

As discussed in greater detail below, certain embodiments also can include a brace (e.g., configured as a truss and manufactured as a unitary piece) that runs along either (or each) side of the caliper. In the preferred embodiments, the reinforcement elements are (or comprise) threaded bolts and/or the first material is (or is comprised of) aluminum and the leading and trailing reinforcement elements are (or are comprised of) steel.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. Certain features of the caliper, such as pistons and hydraulic fittings, that are conventional and/or are not related to the improvements of the present invention either are omitted or are not specifically identified in the drawings and the corresponding discussion below. The following is a brief description of each of the attached drawings.

FIG. 1 is an exploded top perspective view of a monoblock disc brake caliper according to a first representative embodiment of the present invention.

FIG. 2 is a top perspective view of the monoblock disc brake caliper, with reinforcing elements installed, according to the first representative embodiment of the present invention.

FIG. 3 is a bottom perspective view of the monoblock disc brake caliper according to the first representative embodiment of the present invention.

FIG. 4 is a bottom plan view of the monoblock disc brake caliper according to the first representative embodiment of the present invention.

FIG. 5 is a sectional view, taken along the plane shown in FIG. 4, of the monoblock disc brake caliper according to the first representative embodiment of the present invention.

FIG. 6 is an exploded top perspective view of a monoblock disc brake caliper according to a second representative embodiment of the present invention.

FIG. 7 is a top perspective view of the monoblock disc brake caliper, with reinforcing elements installed, according to the second representative embodiment of the present invention.

FIG. 8 is a bottom perspective view of the monoblock disc brake caliper according to the second representative embodiment of the present invention.

FIG. 9 is a bottom plan view of the monoblock disc brake caliper according to the second representative embodiment of the present invention.

FIG. 10 is a sectional view, taken along the plane shown in FIG. 9, of the monoblock disc brake caliper according to the second representative embodiment of the present invention.

### DESCRIPTION OF THE PREFERRED EMBODIMENT(S)

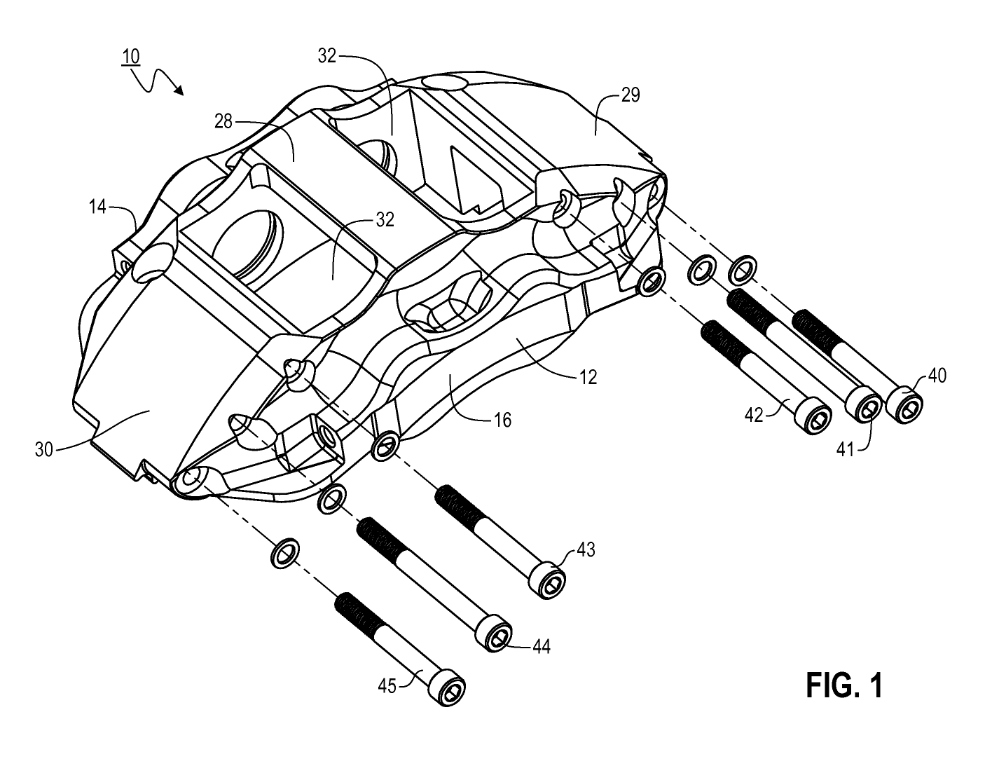

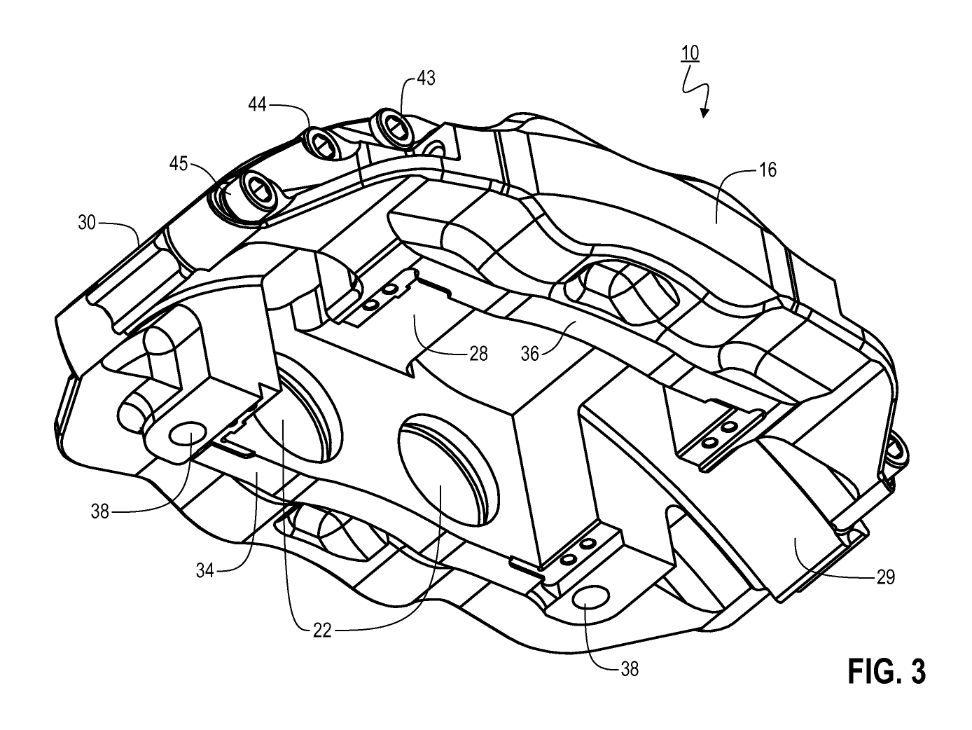

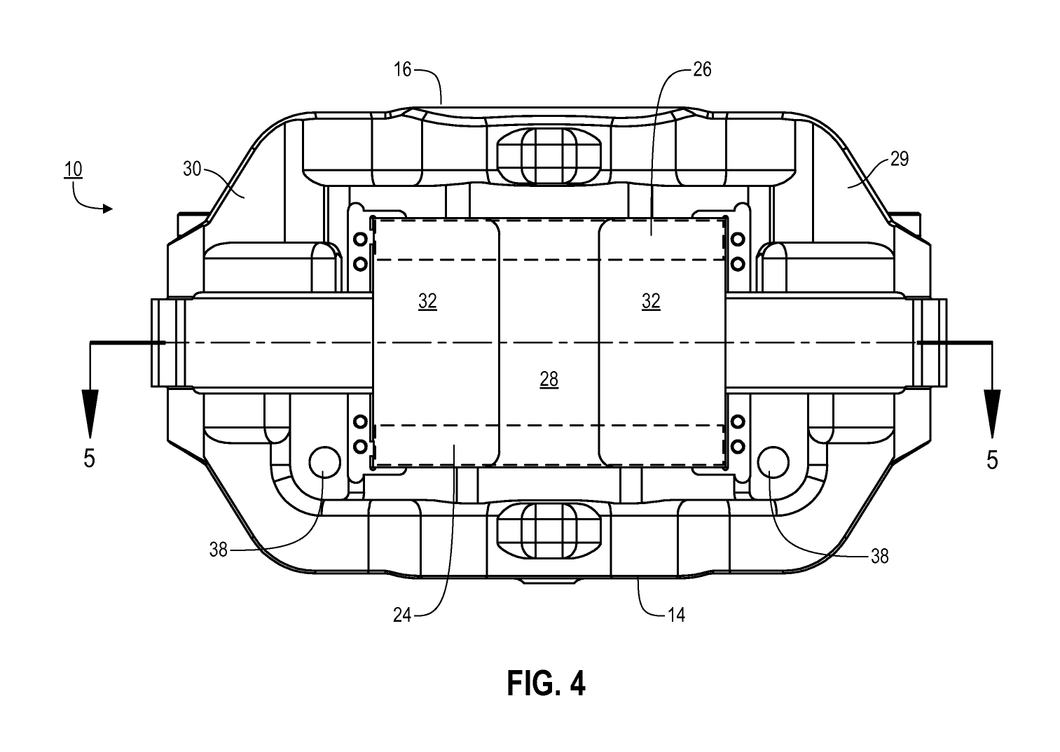

FIGS. 1-5 illustrate a disc brake caliper 10 according to a first representative embodiment of the present invention. As shown, caliper 10 mainly is comprised of a unitary (e.g., forged) main housing 12 that, although manufactured as a single piece, nevertheless can be thought of as including different portions. The inner portion 14 is the portion that is adjacent to the inner side of the brake rotor, while the outer portion 16 is the portion that is adjacent to the outer side of the brake rotor, when caliper 10 is in use. In the preferred embodiments, main housing 12 is entirely, substantially entirely or primarily comprised of aluminum.

In the present embodiment, each of the inner portion 14 and the outer portion 16 includes a pair of hydraulic piston cavities (or bores) 22, into which pistons (not shown) are disposed in normal use. In addition, the inner portion 14 includes an inner opening 24, delimited by end walls 24a and 24b, and the outer portion 16 includes an outer opening 26, delimited by end walls 26a and 26b, respectively. Openings 24 and 26 are located immediately inwardly of the corresponding piston cavities 22, and each such opening 24 and 26 accommodates (and typically closely conforms to the shape of) a corresponding brake pad (not shown). As result, when in use, the pistons on each side press against their corresponding brake pad, effectively squeezing the brake rotor and providing the friction that slows down the vehicle.

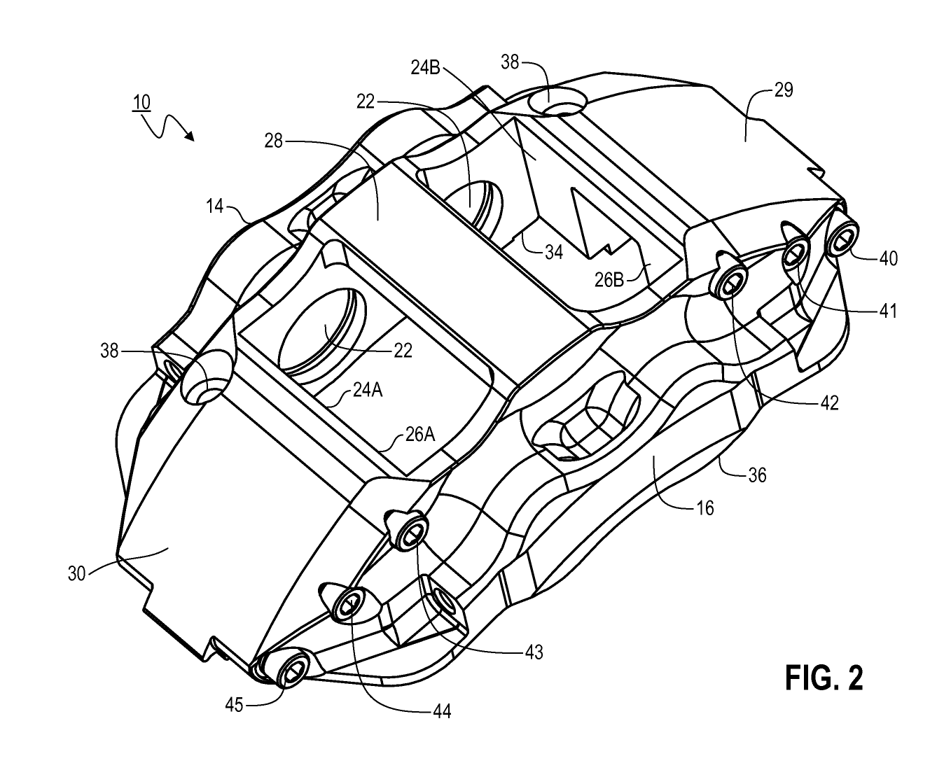

As shown in FIGS. 2-5, both the inner portion 14 and the outer portion 16 of caliper 10 extend additional distances beyond (both forward of and behind) inner opening 24 and outer opening 26. For purposes of the present invention, therefore, each of portions 14 and 16 can be divided into three sections: the middle section that includes opening 24 or 26, the leading section forward of opening 24 or 26, and the trailing section behind opening 24 or 26. As further shown in FIGS. 1 and 2, portions 14 and 16 are attached to each other along each one of these sections. More specifically, bridge 28 attaches portions 14 and 16 above openings 24 and 26, leading crossover section 29 attaches them forward of openings 24 and 26, and trailing crossover section 30 attaches them behind openings 24 and 26. Between bridge 28 and leading crossover section 29 is an opening (or window) 32 and, similarly, between bridge 28 and trailing crossover section 30 is another opening (or window) 32. In the present embodiment, leading crossover section 29 exhibits mirror symmetry with trailing crossover section 30 and, in fact, the entire leading half of caliper 10 exhibits mirror symmetry with its entire trailing half.

As used herein, the term “inner” refers to the portion closer to the centerline of the vehicle and the side where the caliper mounting flange and holes 38 are present to attach the caliper 10 to the vehicle's suspension (not shown), the term “outer” refers to the portion further from the centerline of the vehicle, the term “leading” refers to the section that would be encountered first when the vehicle is moving in a forward direction, and the term “trailing” refers to the section that would be encountered subsequently when the vehicle is moving in a forward direction. In accordance with this terminology, the caliper 10 illustrated in FIGS. 1-5 would be used on the left side of a vehicle if the rotor turned in the counter-clockwise direction.

The present inventor has discovered that the forces provided by pistons, as well as the forces resulting from the friction between the brake pads and the rotor, typically cause a conventional monoblock caliper to deform, thereby reducing braking efficiency. One type of deformation discovered by the present inventor is that the bottom edges 34 and 36 of inner portion 14 and outer portion 16, respectively, would tend to splay apart when braking occurs. In order to address this problem, caliper 10 is provided with a number of reinforcing elements within various portions of caliper 10.

In the preferred embodiments, these reinforcing elements are implemented as bolts (here, bolts 40-45), made of steel or another material having a significantly higher Young's modulus than the material from which caliper 10 is made. More preferably, the Young's modulus of the reinforcing elements is at least 2, 2.5 or 3 times as high as the material from which caliper 10 is made. In the present embodiment, bolts 40-45 extend through washers from the outer portion 16 to the inner portion 14, with bolts 40-42 passing through leading crossover section 29, with bolts 43-45 passing through trailing crossover section 30, and with the inner portion 14 having matching female threads for receiving bolts 40-45. However, any other arrangements of bolts 40-45 instead may be used. Similarly, any other number of bolts (preferably, with the same number extending through leading crossover section 29 and trailing crossover section 30) and/or other kinds of reinforcement elements and/or other structures instead may be used, including threading into nuts that are made of the same or similar material as the bolts.

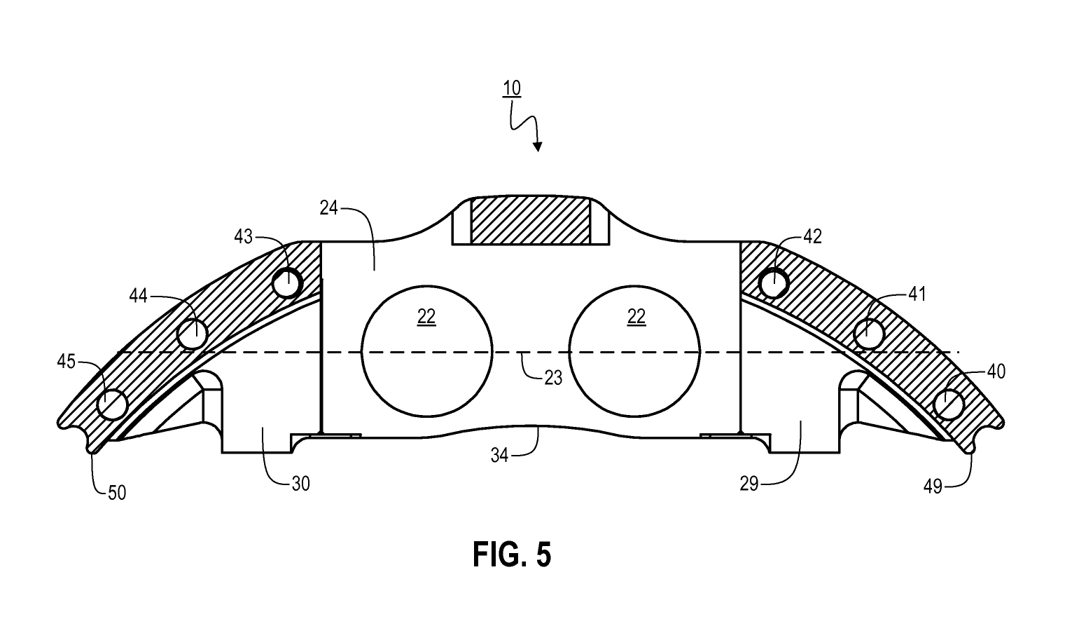

When in use, each of bridge 28, leading crossover section 29 and trailing crossover section 30 extends over the brake rotor. For this reason, the leading crossover section 29 and trailing crossover section 30 generally follow the circular contour of the brake rotor. In the preferred embodiments of the invention, as shown in FIG. 5, the outer edges 49 and 50 of leading crossover section 29 and trailing crossover section 30, respectively, are at a horizontal level that is approximately the same as the horizontal level of the bottom edge 34 of opening 24 (or, correspondingly, bottom edge 36 of opening 26, or the brake pads that fit within them).

Preferably, referring again to FIG. 5, outer bolts 40 and 45 are at a horizontal level that is near the bottom (e.g., entirely or partially within the bottom ½, or ¼) of openings 24 and 26, middle bolts 41 and 44 are at a horizontal level that is near the middle of openings 24 and 26, and inner bolts 42 and 43 are near the top (e.g., entirely or partially within the top ½, or ¼) of openings 24 and 26. Alternately, in the current embodiment the piston cavities 22 have a common horizontal centerline 23, and at least the outer bolts 40 and 45 preferably are partially or completely below such centerline 23. Such reinforcement, particularly in the context of the overall structure of caliper 10 (preferably having the general shape of a longitudinal slice of a cylinder), currently is believed to provide the best protection against undesirable deformation. However, in the event that fewer bolts or other reinforcement elements are used, they preferably are disposed close to the outer edges 49 and 50 (typically meaning at a lower horizontal level) of caliper 10. In fact, in the preferred embodiments, the bolts (or other reinforcing elements) preferably are disposed as low and/or as close to the outer edges 49 and 50 of the main housing 12 as is practical.

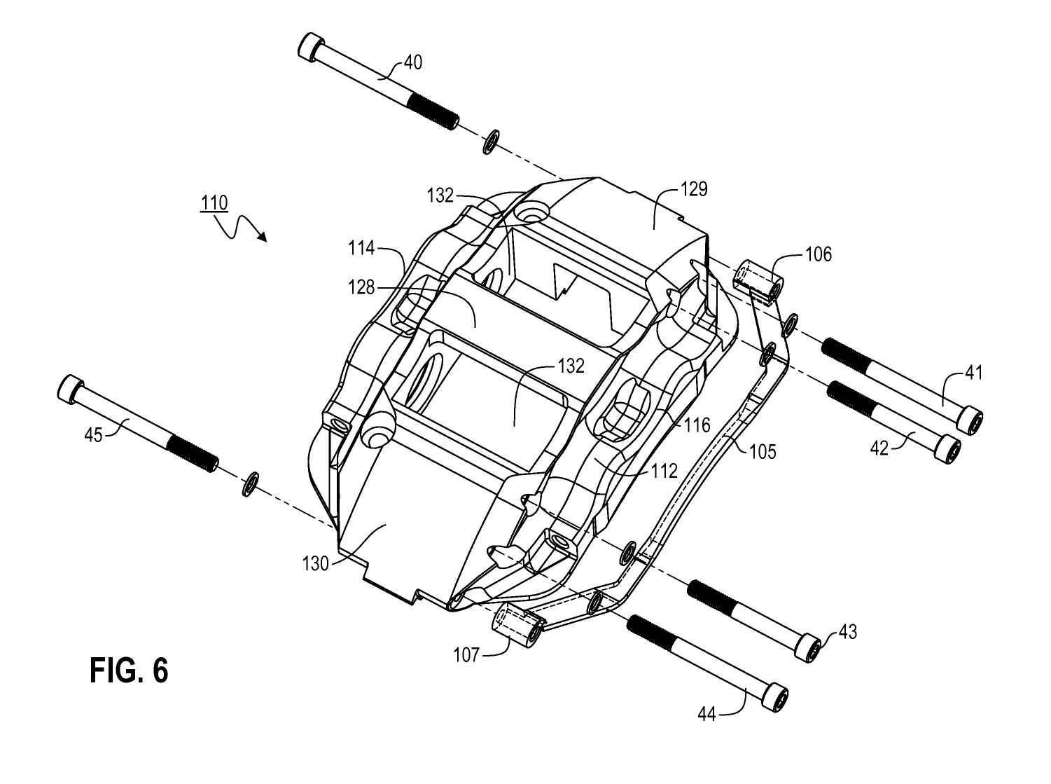

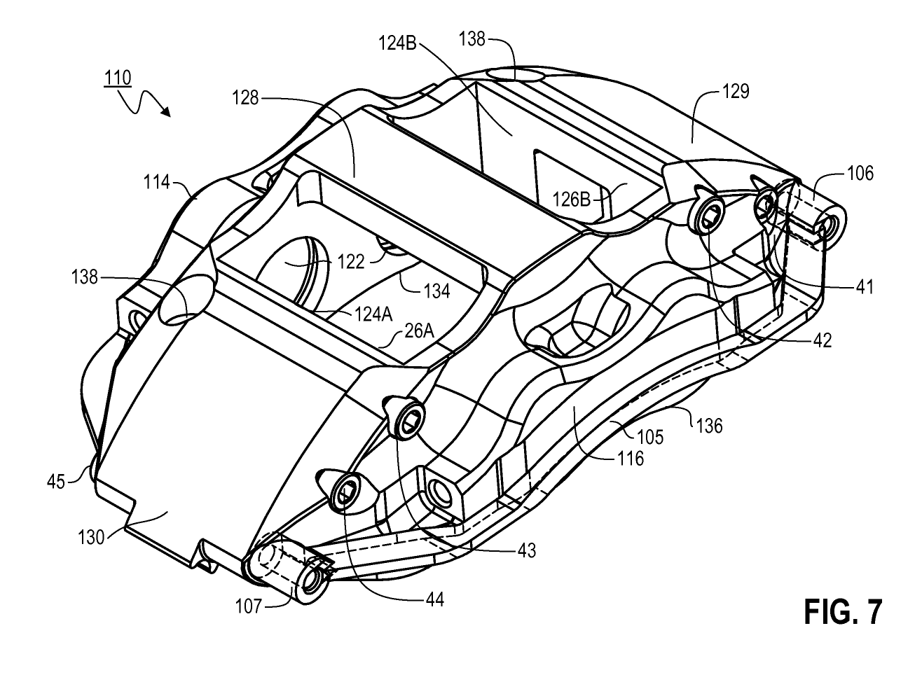

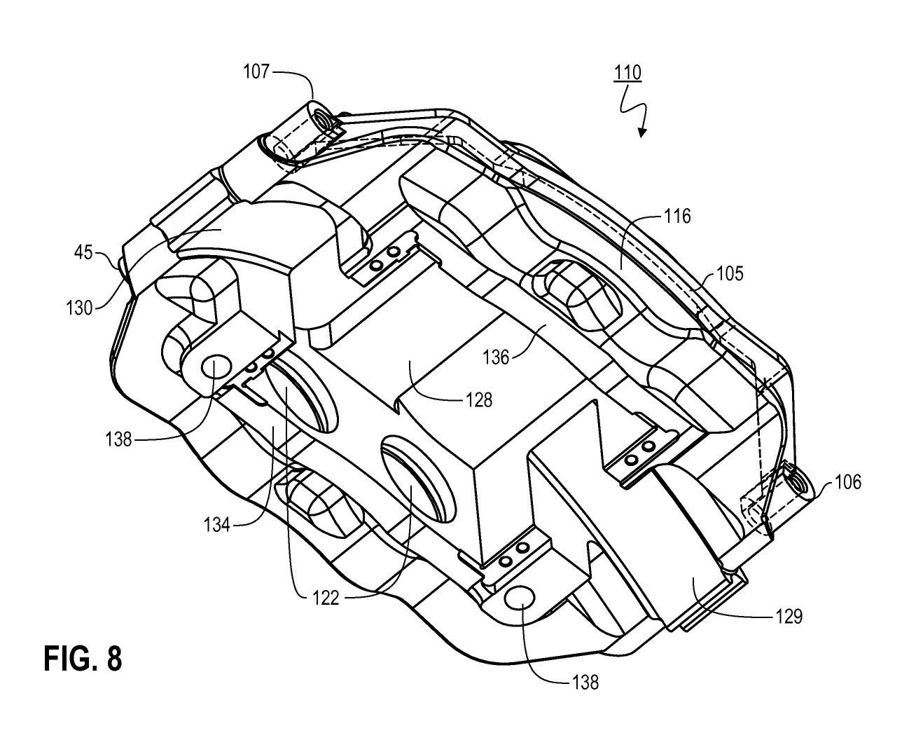

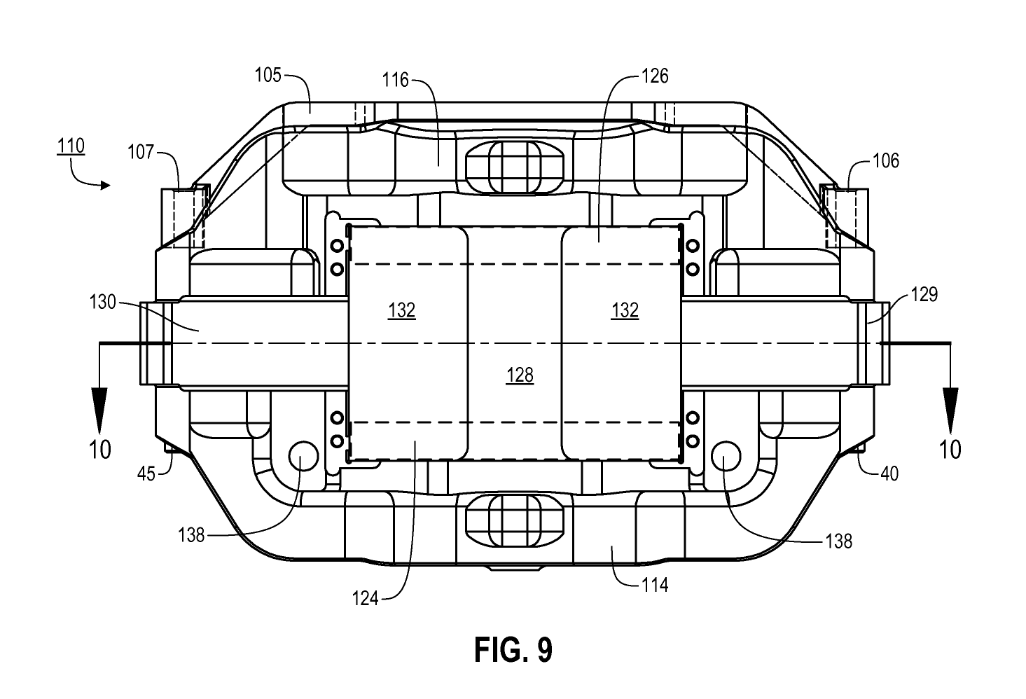

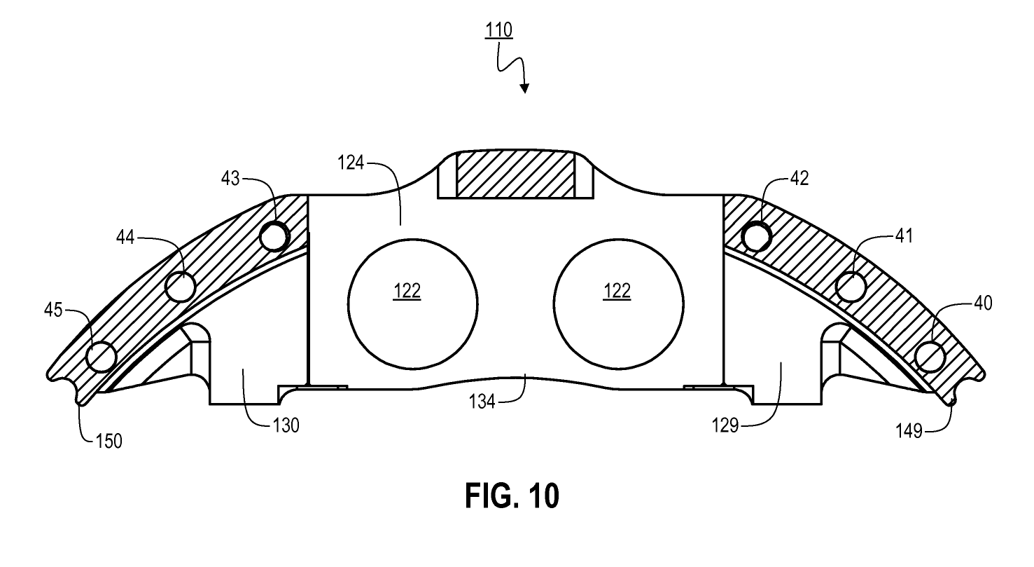

An alternate embodiment of a caliper 110 according to the present invention is illustrated in FIGS. 6-10. As shown, caliper 110 is the same as caliper 10, and the same considerations apply to it as discussed above with respect to caliper 10, except as specifically noted below. Similarly, all other elements in the present embodiment having an element number that is exactly 100 greater than an element number in the first embodiment correspond to such elements in the first embodiment, and the same considerations apply to them, except as specifically noted below.

One of the main difference between caliper 110 and caliper 10 is that caliper 110 includes a brace 105 that extends along the side of outer portion 116 (preferably, substantially the entire length of outer portion 116). In addition, brace 105 includes female-threaded bosses 106 and 107 for accepting bolts 40 and 45, respectively, so that in use, brace 105 is attached to bolts 40 and 45. Also in the present embodiment, bolts 40 and 45 extend from the inner portion 114 to the outer portion 116 through leading crossover section 129 and trailing crossover section 130, respectively, while bolts 141-144 extend from the outer portion 116 to the inner portion 114 through leading crossover section 129 (bolts 41 and 42) and trailing crossover section 130 (bolts 43 and 44), with the inner portion 114 having matching female threads for receiving bolts 41-44.

However, as with the previous embodiment, any other arrangements of bolts 40-45 and/or any other number of bolts (preferably, with the same number extending through leading crossover section 129 and trailing crossover section 130) and/or other reinforcement elements (e.g., rivets) instead may be used. Also, a similar brace also (or instead) may run along the side of inner portion 14.

In the current embodiment, brace 105 is configured as a truss which has been manufactured as a unitary piece. However, in alternate embodiments it may have any other configuration, such as a band or a plate, and/or it may be manufactured from several different pieces that are attached together.

### Additional Considerations.

In the event of any conflict or inconsistency between the disclosure explicitly set forth herein or in the attached drawings, on the one hand, and any materials incorporated by reference herein, on the other, the present disclosure shall take precedence. In the event of any conflict or inconsistency between the disclosures of any applications or patents incorporated by reference herein, the more recently filed disclosure shall take precedence.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A disc brake caliper, comprising:
a unitary main housing made of a first material and including: (a) an inner portion that is adjacent to an inner side of a brake rotor when in use and includes an inner opening for receiving an inner brake pad, (b) an outer portion that is adjacent to an outer side of a brake rotor when in use and includes an outer opening for receiving an outer brake pad, (c) a leading crossover section that extends between the inner portion and the outer portion, forward of both the inner opening and the outer opening, and over the brake rotor when in use, and (d) a trailing crossover section that extends between the inner portion and the outer portion, behind both the inner opening and the outer opening, and over the brake rotor when in use;
a leading reinforcement element extending between the inner portion and the outer portion through the leading crossover section; and
a trailing reinforcement element extending between the inner portion and the outer portion through the trailing crossover section,
each said leading and trailing reinforcement element having a Young's modulus that is at least twice that of the first material.

2. A disc brake caliper according to claim 1, further comprising:
a second leading reinforcement element extending between the inner portion and the outer portion through the leading crossover section; and
a second trailing reinforcement element extending between the inner portion and the outer portion through the trailing crossover section,
each said second leading and second trailing reinforcement element having a Young's modulus that is at least twice that of the first material.

3. A disc brake caliper according to claim 1, wherein said reinforcement elements comprise threaded bolts.

4. A disc brake caliper according to claim 1, wherein the first material is comprised of aluminum and the leading and trailing reinforcement elements are comprised of steel.

5. A disc brake caliper according to claim 1, wherein each of the inner portion and the outer portion includes at least two hydraulic piston chambers.

6. A disc brake caliper according to claim 1, wherein the inner portion includes a hydraulic piston chamber, but the outer portion does not.

7. A disc brake caliper according to claim 1, further comprising a bridge that extends between the inner portion and the outer portion above both the inner opening and the outer opening.

8. A disc brake caliper according to claim 1, further comprising a brace that extends along an outer surface of at least one of the inner portion and the outer portion and that attaches to the leading reinforcement element near a leading end of the brace and attaches to the trailing reinforcement element near a trailing end of the brace.

9. A disc brake caliper according to claim 8, wherein the brace is configured as a truss.

10. A disc brake caliper according to claim 9, wherein the brace is a unitary piece.

11. A disc brake caliper according to claim 8, wherein the brace has a Young's modulus that is at least twice that of the first material.

12. A disc brake caliper according to claim 8, wherein the brace extends along the outer surface of the outer portion, the outer portion being adjacent to an outer surface of the brake rotor.

13. A disc brake caliper according to claim 1, wherein each of said leading reinforcement element and said trailing reinforcement element has a Young's modulus that is at least 2½ times that of the first material.

14. A disc brake caliper according to claim 1, further comprising a piston cavity having a horizontal centerline, and wherein at least a portion of each said leading and trailing reinforcement element is disposed at a horizontal level that is below the centerline of the piston cavity.

15. A disc brake caliper according to claim 1, further comprising a piston cavity having a horizontal centerline, and wherein each said leading and trailing reinforcement element is entirely disposed at a horizontal level that is below the centerline of the piston cavity.

16. A disc brake caliper according to claim 1, wherein said leading and trailing reinforcement elements are disposed close to outer edges of the unitary main housing.
